(19) United States
(12) Patent Application Publication
(10) Pub. No.: US 2011/0017309 A1
(43) Pub. Date: Jan. 27, 2011

(54) PUMP WITH INTEGRAL CAISSON DISCHARGE

(75) Inventors: Mirja Koekenbier, Timmendorfer Strand (DE); Axel Helmut Tank-Langenau, Remmels (DE); Thomas Albers, Ahrensburg (DE)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: FLOWSERVE MANAGEMENT COMPANY, Irving, TX (US)

(21) Appl. No.: 12/843,528

(22) Filed: Jul. 26, 2010

Related U.S. Application Data
(60) Provisional application No. 61/228,717, filed on Jul. 27, 2009.

(51) Int. Cl. G05D 7/00; F04D 25/06

(52) U.S. Cl. 137/12; 417/423.3; 137/565.01

(57) ABSTRACT

A caisson for submersible pumps and method of operating a pump that is fluidly cooperative with the caisson. The pump discharge and the caisson are fluidly coupled to one another such that upon discharge of a fluid being pumped, the caisson acts as the fluid conduit, thereby removing the need for redundant riser pipes. In one form, the pump is a seawater lift pump for use with floating production storage and offloading (FPSO), offshore platforms or related structures.

This application claims the benefit of the filing date of U.S. Provisional Application No. 61/228,717, filed Jul. 27, 2009.

### BACKGROUND OF THE INVENTION

This invention relates generally to a pump assembly for submerged operations, such as those used in platforms and related offshore structures, and more particularly to a pump assembly with reduced component redundancy.

Much of the world's extraction of oil and gas comes from offshore structures. In one form of such a facility or site, a floating production storage and offloading (FPSO) facility, typically in the form of a ship, employs one or more seawater lift pumps (SWLPs) to convey the seawater to a deck level of the facility for use in engine cooling, air conditioning, compressor use, water injection, production requirements or general service water. Such pumps, which are submersible, can be situated either on the outside of the hull or the inside. In another form of an offshore structure, an offshore platform may be outfitted with SWLPs. SWLPs for use on either the FPSO or offshore platform are often powered by an electric motor; in such case, they are part of a class of pumps known as electric submersible pumps (ESPs) which may include either a middle-intake or bottom-intake configuration. In the former (more common) configuration, the motor is situated below the pump, while in the latter, the motor is above the pump and is often utilized for situations where limited submergence results in low net positive suction head (NPSH) and is needed to avoid the bottom of the unit substantially projecting from the bottom of the FPSO or offshore platform. Risers (or similar piping) that are typically located at the SWLP discharge may be used to convey the pumped seawater to a desired end use within the FPSO or offshore platform, such as those mentioned above. In a conventional SWLP design, the pump is supported by such piping connected to the pump discharge.

In either of the above offshore production configurations, it is conventional to use a caisson as a secondary fluid vessel around SWLPs to protect the pump during operation against wave motion, as well as changes in water current or the presence of flotsam in the water. Such caissons may be used for both the aforementioned middle-intake and bottom-intake SWLP construction. In a conventional configuration, the SWLP is installed at the bottom of an open caisson that is submerged in the seawater. As with the riser discussed above, the caisson is typically of elongate cylindrical construction, and includes an inner space possessive of sufficient volume to house the pump and its associated electrical power leads, control lines, the riser and other service lines. Caissons are typically made from conventional structural materials, including steel or the like. In the present context, a caisson can be a pipe, frame or related structure in which pumps can be installed. Their use is convenient on FPSOs and other offshore platforms, but is also suitable in other applications, such as caverns or the like.

The risers used for offshore structures typically pass through a top (or cover) plate of the caisson. Features such as this, as well as the nature of the overlapping use of concentric risers and caissons introduces additional weight and complexity to both the FPSO and offshore platform configurations. In addition, the possibility of friction losses, galvanic corrosion (such as due to the presence of disparate metal structures in contact with one another in a saltwater environment), relatively unstable high center-of-gravity and other technical difficulties may be present with a conventional SWLP-caisson combination. Without a continuous flow of seawater, the corrosion problem can be exacerbated by a region within the riser that can accumulate stagnant water. For at least these reasons, it is desirable to reduce these weight, complexity and susceptibility to corrosion problems.

### SUMMARY OF THE INVENTION

This desire is met by the present invention, where in one aspect thereof, a SWLP assembly is disclosed. The pump (such as an ESP) is encased in the bore of a caisson so that seawater is discharged from the pump to flow directly through the bore without the need for a now-redundant riser. Such design (referred to herein as a riserless design or a riserless pump and caisson combination) avoids having to use riser pipes over the length of the caisson in order to convey the seawater to the deck level of an FPSO, platform or related facility. Advantages associated with using the caisson as discharge include lower price per installation (due to the removal of costly discharge (riser) pipes) relative to a traditional configuration that employs a riser and reduced installation time, lower center of gravity as well as possible reduction in weight. Likewise, the galvanic corrosion problem discussed above is reduced or eliminated, as the riser structure is no longer present. In addition, the design of the upper pressurized caisson section is such that it facilitates the continuous flow of seawater, thereby minimizing or eliminating the presence of stagnant seawater and the concomitant corrosion problem and reducing or even eliminating the need of using anodes. Such elimination or reduction is additionally helpful in reducing weight, cost and installation time. The riserless seawater lift pump assembly includes a seawater lift pump with both a motor section and a pumping section. The pumping section includes a seawater inlet, a seawater outlet and a pump impeller, rotor or related pressure-imparting means to pressurize the fluid between the seawater inlet and the seawater outlet. The caisson is fluidly cooperative with the pumping section such that pressurized seawater being discharged through the outlet forms a flowpath that is defined by the caisson. By having the flowpath be defined in this way (i.e., by the caisson), the inner wall of the caisson is in contact with the pumped seawater such that it serves as a channel or related guide for the pressurized water. In such a configuration, there is no riser or other intermediate piping used to form the flowpath for the pressurized fluid leaving the pump section. Such reduction in redundant structure may result in weight savings for the assembly.

In one optional configuration, the motor is mounted below the pump suction in the aforementioned middle-intake design. In this way, standard submersible motors and motor housings may be used, as the pressure environment about the motor is merely the ambient pressure of the fluid to be pumped, rather than the elevated pressure associated with the pump discharge. This is one form of cost and weight savings, as such a configuration permits use of a standard submersible motor design. In another configuration, the motor is situated above the pump (i.e., the bottom-intake design) to reduce the required pump operating water depth and to keep the protrusion associated with the pump intake to a relatively short vertical length.

In other options, the assembly can be secured to an offshore structure, such as an FPSO facility or an offshore platform. When connected to an FPSO, one or both of the seawater lift pump and the caisson can be situated either inside the FPSO facility's hull or outside of it. Likewise, it will be appreciated by those skilled in the art that the use of the riserless configuration is not limited to offshore platforms or FPSO structures, but can be used in situations where the use of a caisson is conventional or expected, an example of which includes caverns used for the storage of oil, gas and related valuable natural resources. As such, the use of the riserless configuration of the present invention is not limited to pumping seawater.

According to another aspect of the invention, a method of pumping seawater is disclosed. The method includes discharging pressurized seawater from a SWLP assembly such that a substantial entirety of a flowpath formed by the discharged seawater is defined by a caisson that, along with the pump, makes up the assembly. The lift pump is configured to include a pump inlet, a pump outlet and an impeller, rotor or related pressurizing member fluidly coupled to the inlet and outlet.

In one optional form, the caisson is affixed (such as by a flanged, bolted arrangement) or otherwise coupled to the seawater lift pump to be in fluid communication with a pressurized water outlet formed as part of the pump. By having the substantial entirety of the discharged seawater flowpath defined by the caisson, the method of the present invention avoids having to use a riser or other intermediate structure that (if present) would add significant weight and complexity to the seawater lift pump assembly. In such configuration, the upper wall of the caisson is in direct contact with at least a portion of the pressurized seawater, while a lower wall of the caisson is in direct contact with ambient seawater that surrounds the pump. In another option, the seawater lift pump can be of either a middle-intake design or a bottom-intake design as discussed above in conjunction with the previous aspect. The method may additionally include placing the caisson in fluid communication with an offshore structure, such as a FPSO or offshore platform, in order to deliver the pressurized seawater to such structure. In the case of an FPSO, the caisson can be placed either inside or outside of the FPSO's hull. In addition, the caisson may be secured or affixed to the hull.

### BRIEF DESCRIPTION OF THE DRAWINGS

The following detailed description of the present invention can be best understood when read in conjunction with the following drawings, where like structure is indicated with like reference numerals and in which:

FIG. 1 is an elevation view of a conventional SWLP pump according to the prior art, where the riser or discharge pipes extending from the pump discharge are coaxially disposed within a caisson;

FIGS. 2A and 2B show respectively a middle intake ESP and a bottom-intake ESP that are each usable in the riserless design of the present invention;

FIG. 3 is an elevation view of a middle intake caisson pump according to an aspect of the present invention;

FIGS. 4A and 4B show an FPSO with SWLPs mounted on the inside and the outside of the hull respectively;

FIGS. 5A and 5B show an offshore platform with a middle-intake SWLP and a bottom-intake SWLP, respectively; and

FIGS. 6A and 6B show alternate riserless offshore platform SWLP mounting configurations according to an aspect of the present invention.

### DETAILED DESCRIPTION OF THE PREFERRED EMBODIMENTS

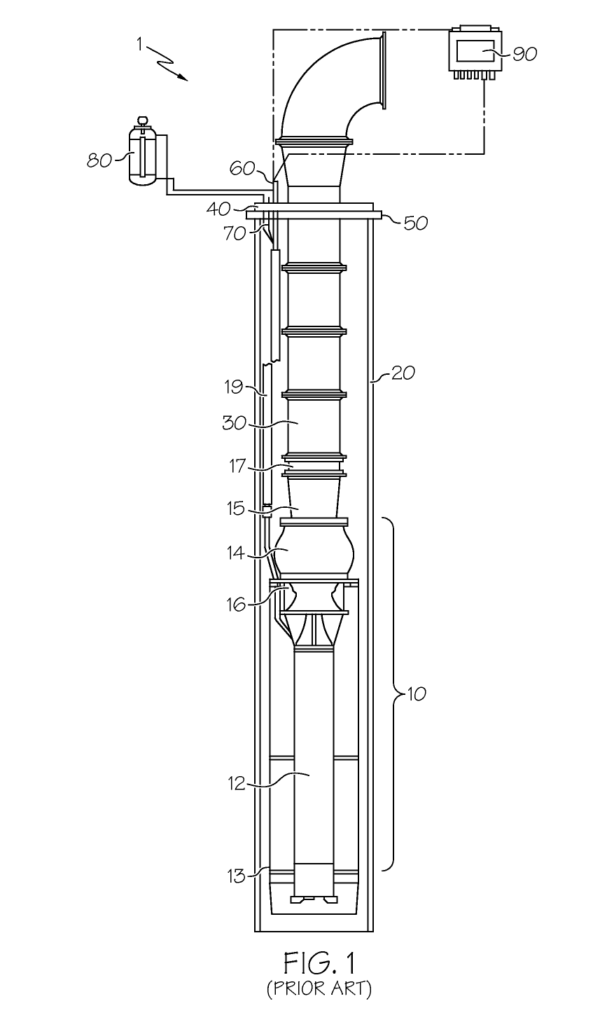

Referring initially to FIG. 1, a seawater lift pump assembly 1 according to an aspect of the prior art is shown. The assembly 1 includes a seawater lift pump 10 that includes a motor section 12 and a pump section 14 with intake 16, and is disposed within, and generally secured to, a caisson 20. The corrosive nature of seawater is such that the seawater lift pump 10 and all associated parts such as risers are made from materials (such as bronze, stainless steel, duplex and various nickel-based compounds) that can withstand such an environment. Likewise, the construction of such seawater lift pump 10 is such that it can withstand the environments associated with deep subsurface placement. Additional components may make up the balance of the assembly, including a cooling shroud 13 that surrounds the motor section 12, and adapter 15 and non-return flap 17 situated at the outlet of pump 14, as well as flexible tubes 19 (only one of which is shown) that extends from the header tank 80 at the top and run the axial length of the assembly 1; such tubes 19 are used for motor cooling fluid or the like. For example, such tubes 19 may include a tube for filling and a tube for venting between the motor section 12 and the header or top of the assembly 1.

A fluid conduit, otherwise known as a riser 30, is secured to the outlet of the pump 10 in order to convey the seawater being pumped therefrom to a desired location. The riser 30 is shown having numerous axially-connected sections that extend upwardly from the discharge of pump section 14. As such, there is a concentric arrangement of the riser 30 within the caisson 20 such that both can be supported by a cover plate 40, such as attaching the caisson 20 through a flange 50. Caisson cover plate 40 and flange 50 may be secured to one another such that a gasket (not shown) is disposed between them. Additional equipment, such as power cable 60 to deliver electrical current to motor section 12, a signal cable 70 and pipes to a header tank 80, as well as a junction box 90 for the power cable 60 and signal cable 70 are shown, where at least the cables 70 and 80 can be placed between the riser 30 and the caisson 20. In a typical medium-sized configuration, the length and diameter of the seawater lift pump 10 is approximately 20 feet and 4.5 feet respectively, and the length and diameter of the riser 30 is approximately 100 feet and 4 feet respectively. Such a seawater lift pump assembly 1 with such dimensions (and including other miscellaneous items, such as a non-return flap, adapter, well head, cooling shroud, cables and various accessories) may weigh upwards of 45,000 to 50,000 pounds.

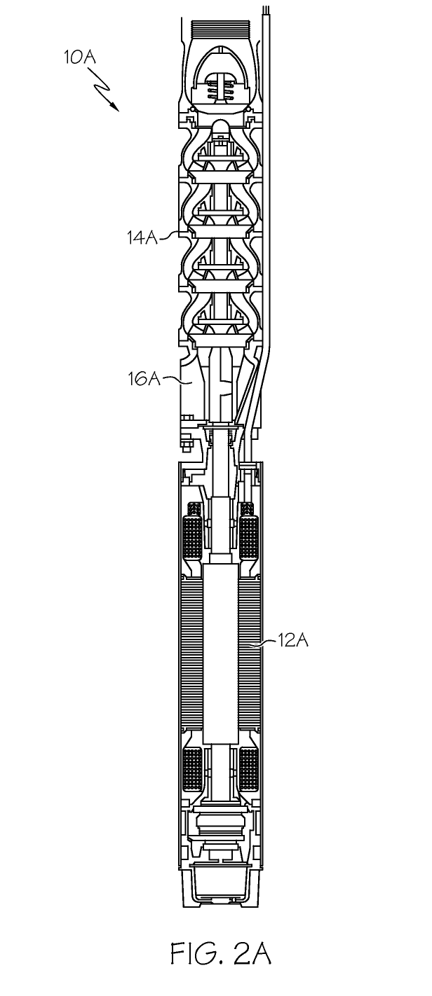

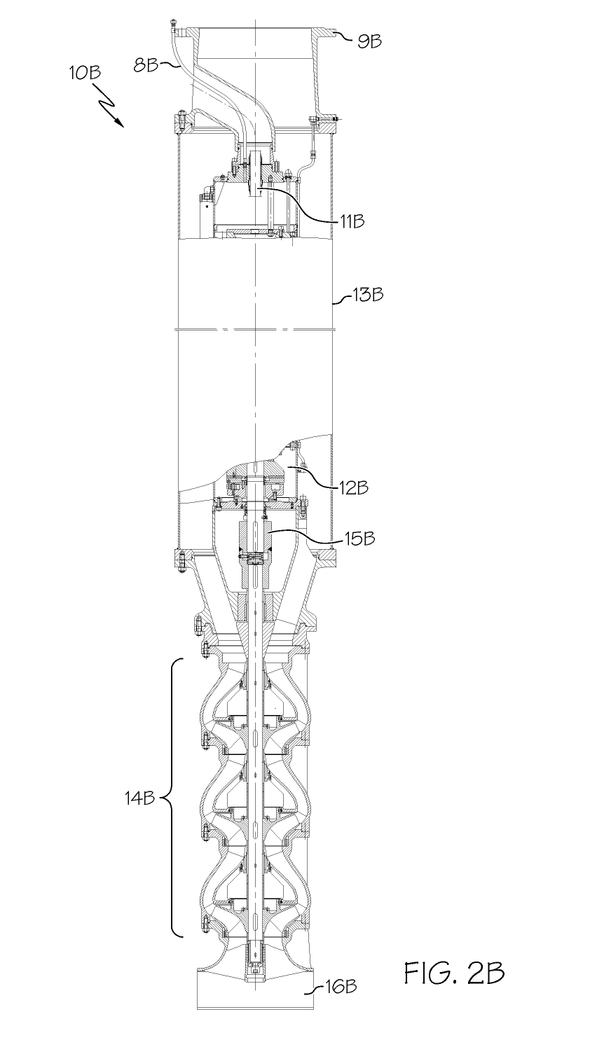

Referring next to FIGS. 2A and 2B, examples are shown of both a middle intake pump 10A and a bottom intake pump 10B that can be used in assembly 1. As shown with particularity in FIG. 2A, pump section 14A of the middle intake configuration may be made up of numerous axially-aligned impellers. In such case, an intake 16A is formed between the motor section 12A and the pump section 14A to permit the seawater to be introduced to the lowermost of the impellers. Likewise, as shown with particularity in FIG. 2B, pump section 14B of the lower intake configuration has one or more impellers, this time situated adjacent intake 16B that forms the lowermost portion of the pump 10B; such a configuration is particularly compatible with limited water depths. The partial cutaway view depicted in FIG. 2B shows a shroud 13B about the motor section 12B, and a coupling 15B to rotatably connect the shafts of the pump and motor sections 14B and 12B, as well as how such sections can be bolted together at flanges situated at adjacent axial ends of each section. Cable sealing 11B can be used to provide environmental protection for the electric power cable, while a filling hose and connection 8B are shown to allow cooling for motor section 12B. A discharge housing 9B can be bolted or otherwise connected to shroud 13B.

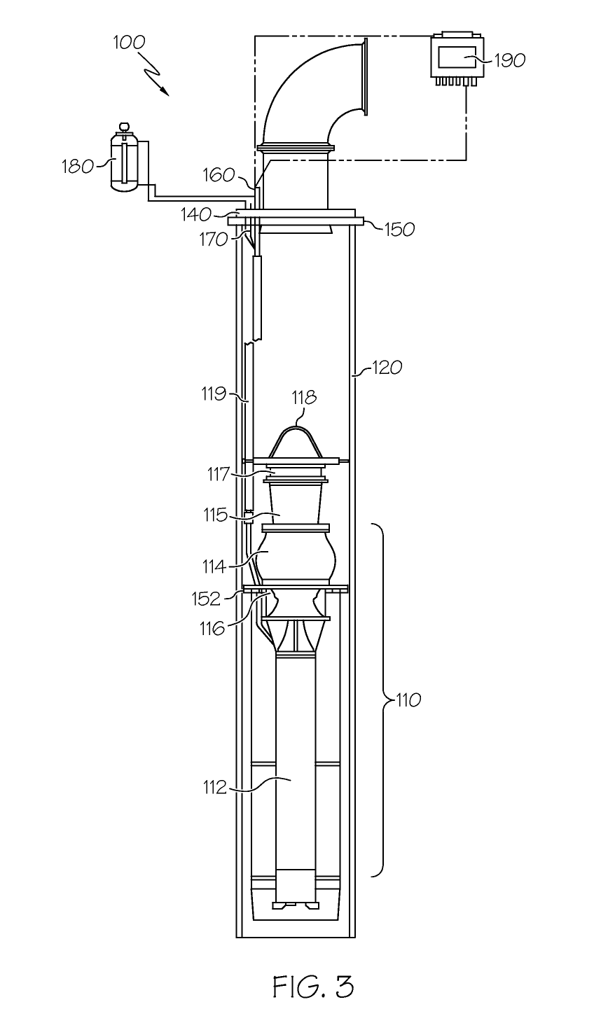

Referring to FIG. 3, a seawater lift pump assembly 100 according to an aspect of the present invention is shown. The assembly 100 includes a seawater lift pump 110 encased within a caisson 120. Pump 110 includes a motor section 112 and a pump section 114 with intake (also referred to as a suction housing) 116 and non-return flap 117 and adapter 115, yet unlike the assembly 1 depicted in FIG. 1, has no riser extending from its discharge or outlet, instead forming a direct fluid connection with caisson 120. In the present context, such a configuration is considered to be riserless. In other aspects, seawater lift pump assembly 100 includes a header tank 180 and junction box 190 in a manner generally similar to that of assembly 1. In the assembly 100 of the present invention, the caisson 120 forms a substantially fluid-tight conduit through which seawater or other fluid that exits the pump section 114 discharge can flow. In this configuration, there is then no need for a riser (such as riser 30 of the assembly 1 of FIG. 1). Additional equipment, such as power cable 160 and signal cable 170, are also shown. Flange 150 formed at the top of the caisson 120 and underneath the cover plate (also called a caisson mating flange) 140 is used to secure the seawater lift pump 110 to the caisson 120 Likewise, a pump supporting flange 152 is situated within caisson 120 for pump 110. The riserless configuration of the present invention preferably includes a pressure-tight connection between the cover plate 140 and flange 150. The pump 110 is fitted and sealed to the caisson by means of a splined ring with pin (neither of which are shown), or a related fastening mechanism. This prevents turning of the pump 110 during start and stop operations. Furthermore, a gasket (not shown) will be used to seal the pump 110, relying upon the weight of the unit itself to form the seal. The pump 110 can be raised and lowered by a conventional lifting device 118 known to those skilled in the FPSO and offshore platform art. In contrast to the typical seawater lift pump configuration shown in FIG. 1, the seawater lift pump assembly 100 with comparable length and diameter dimensions (and including similar miscellaneous items discussed above) may weigh about 35,000 pounds, saving between about 10,000 and 15,000 pounds. Other features are generally similar to the assembly 1 of FIG. 1, such as a motor cooling fluid flexible tube 119.

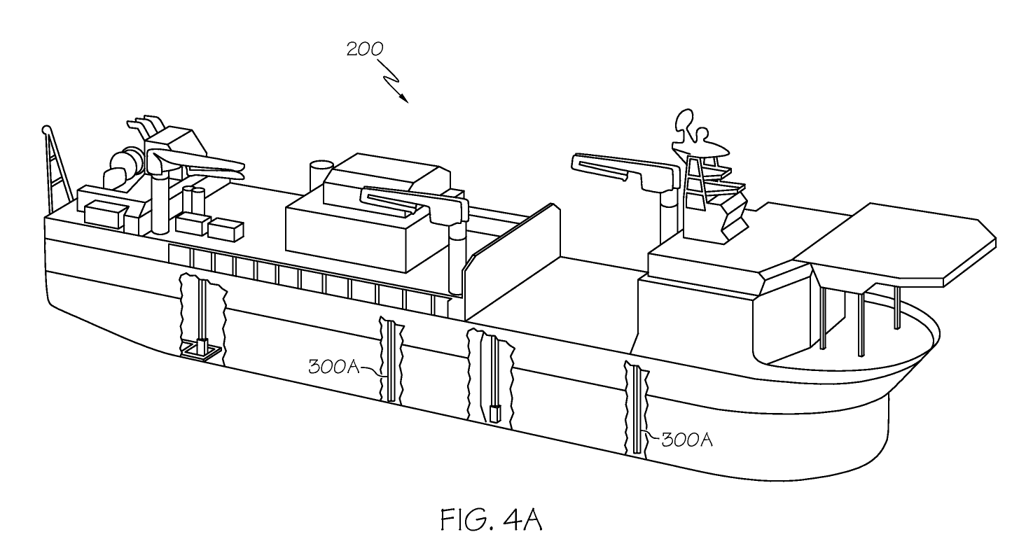

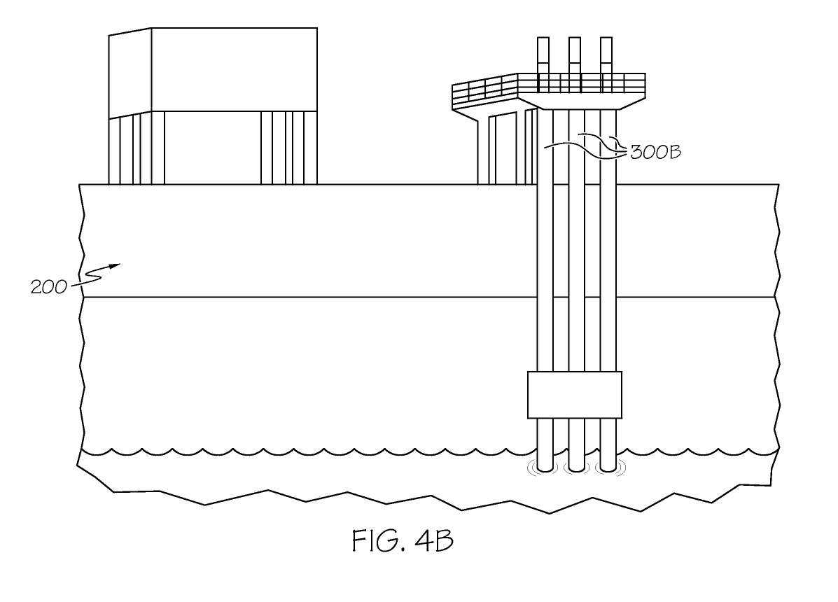

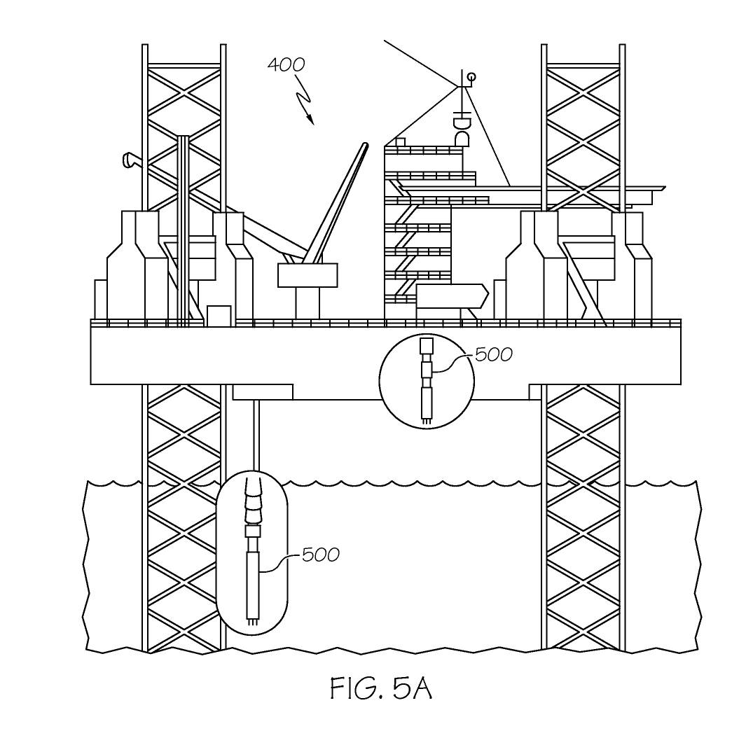

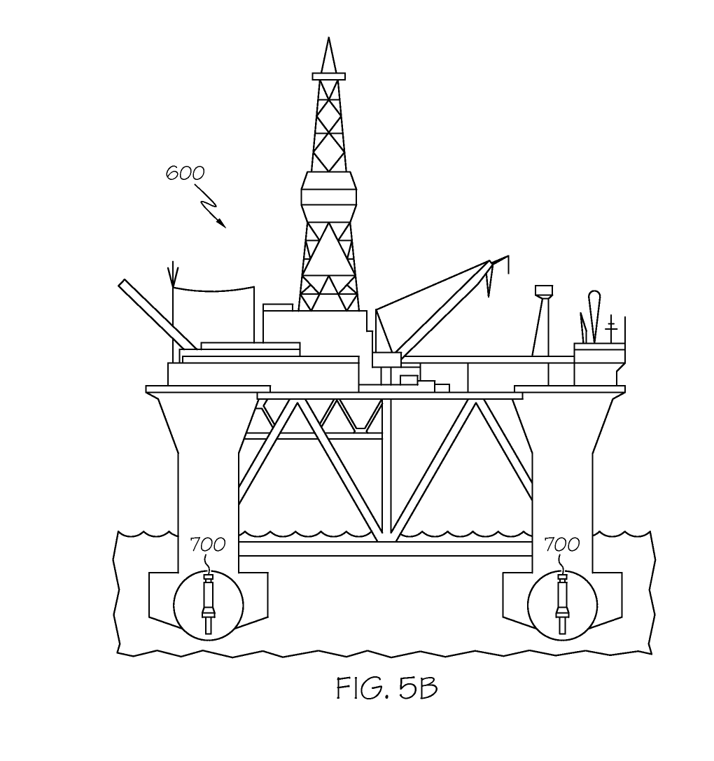

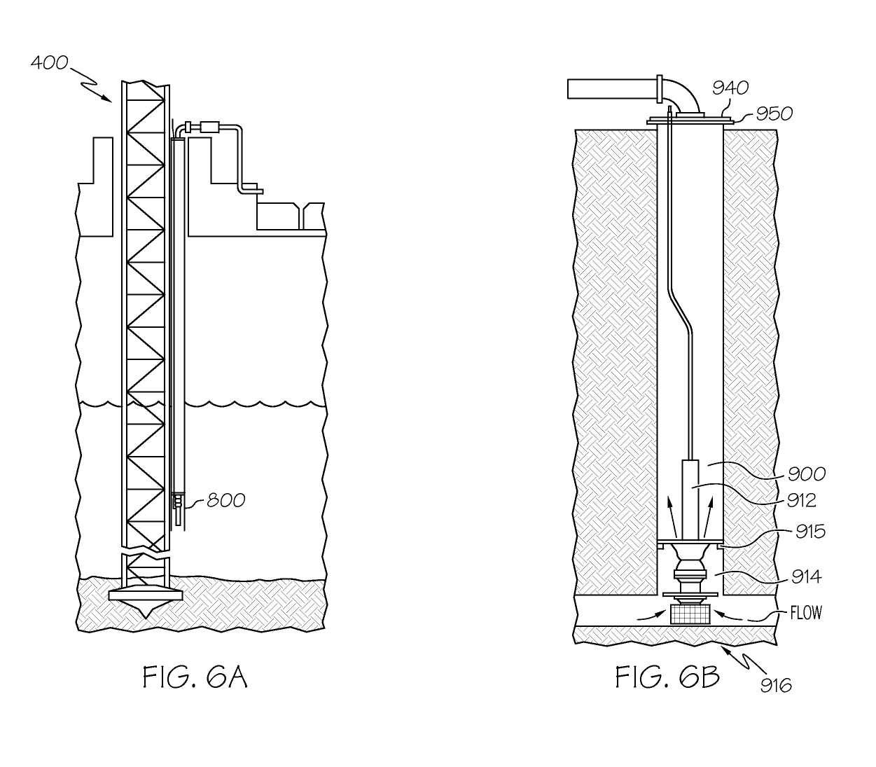

FIGS. 4A, 4B, 5A, 6A and 6B show other SWLP configurations in simplified form for clarity. These SWLPs can be employed in numerous locations, including on an FPSO 200 (shown as internal SWLPs 300A in FIG. 4A and external SWLPs 300B in FIG. 4B). Likewise, FIGS. 5A and 5B show offshore platforms 400, 600 with middle-intake SWLPs 500 and bottom-intake SWLPs 700, respectively. FIG. 6A shows an alternate riserless offshore platform 400 (which is generally similar to that of the platform 400 SWLP in FIG. 5A) with mounting configurations for SWLPs 800 (in FIG. 6A) and 900 (in FIG. 6B). The bottom-intake configuration of SWLP 900 shown in FIG. 6B includes a motor section 912, a pump section 914 with intake 916. A supporting ring 915 is formed between the pump section 914 and the motor section 912, and is sized to allow axial passage of the pump 900 (including its widest part just above the suction strainer of intake 916. Further, and in a manner generally similar to that of FIG. 3, a pressure-tight connection between the cover plate 940 and flange 950 forms the top of the assembly of SWLP 900.

While certain representative embodiments and details have been shown for purposes of illustrating the invention, it will be apparent to those skilled in the art that various changes may be made without departing from the scope of the invention, which is defined in the appended claims.

What is claimed is:

1. A riserless seawater lift pump assembly comprising:
a seawater lift pump comprising a motor section and a pumping section cooperative therewith, said pumping section comprising at least a seawater inlet, a seawater outlet and a pressure-imparting means disposed fluidly between said seawater inlet and said seawater outlet, said pressure-imparting means configured to operate in response to a motive force provided by said motor section; and
a caisson fluidly cooperative with said pumping section such that pressurized seawater being discharged through said seawater outlet forms a flowpath that is defined by said caisson.

2. The assembly of claim 1, wherein said seawater lift pump comprises a middle-intake design where said motor section is disposed axially below said pumping section.

3. The assembly of claim 1, wherein said seawater lift pump comprises a bottom-intake design where said motor section is disposed axially above said pumping section.

4. The assembly of claim 1, further comprising an offshore structure to which at least one of said seawater lift pump and said caisson is secured.

5. The assembly of claim 4, wherein said offshore structure comprises a floating production and storage offloading facility.

6. The assembly of claim 5, wherein said at least one of said seawater lift pump and said caisson is situated inside a hull of said floating production and storage offloading facility.

7. The assembly of claim 5, wherein said at least one of said seawater lift pump and said caisson is situated outside a hull of said floating production and storage offloading facility.

8. The assembly of claim 4, wherein said offshore structure comprises an offshore platform.

9. The assembly of claim 1, wherein said caisson is mechanically secured to said seawater lift pump.

10. A method of pumping seawater comprising discharging pressurized seawater from a seawater lift pump assembly comprising a seawater lift pump and a caisson such that a substantial entirety of a flowpath formed by said discharged seawater is defined by said caisson.

11. The method of claim 10, wherein said caisson is affixed to said seawater lift pump to be in fluid communication with a pressurized water outlet formed therein.

12. The method of claim 10, wherein said caisson is configured such that during said pumping, an upper section wall thereof is in direct contact with at least a portion of said pressurized seawater while an lower section wall is in direct contact with ambient seawater.

13. The method of claim 10, wherein said seawater lift pump comprises a middle-intake design such that a motor section thereof is disposed axially below a pumping section thereof.

14. The assembly of claim 10, wherein said seawater lift pump comprises a bottom-intake design such that a motor section thereof is disposed axially above a pumping section thereof.

15. The method of claim 10, further comprising placing said caisson in fluid communication with an offshore structure in order to deliver said pressurized seawater thereto.

16. The method of claim 15, wherein said offshore structure comprises a floating production and storage offloading facility.

17. The method of claim 16, wherein said caisson is situated inside a hull of said floating production and storage offloading facility.

18. The method of claim 16, wherein said caisson is situated outside a hull of said floating production and storage offloading facility.

19. The method of claim 10, further comprising maintaining a substantially continuous flow of seawater through at least an upper portion of said caisson.
